(19) United States
(12) Patent Application Publication
(10) Pub. No.: US 2008/0278464 A1
(43) Pub. Date: Nov. 13, 2008

(54) Pixel circuit and display device

(75) Inventors: Tetsuro Yamamoto, Kanagawa (JP); Katsuhide Uchino, Kanagawa (JP); Junichi Yamashita, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/081,722

(22) Filed: Apr. 21, 2008

(30) Foreign Application Priority Data
May 9, 2007 (JP) 2007-124261

(51) Int. Cl. G06F 3/038; G09G 3/34

(52) U.S. Cl. 345/204; 345/84

(57) ABSTRACT

A pixel circuit includes an electro-optical element configured to emit light in response to a drive signal, a drive transistor configured to supply the drive signal to the electro-optical element, a pixel capacitor connected to a control input terminal of the drive transistor, a switching transistor provided at the control input terminal of the drive transistor, and a drive-signal stabilizing circuit configured to maintain the drive signal at a constant level. Each of the drive transistor and the switching transistor has a lightly doped drain structure, and a lightly doped drain region of the switching transistor has a longer length than a lightly doped drain region of the drive transistor.

### CROSS REFERENCES TO RELATED APPLICATIONS

The present invention contains subject matter related to Japanese Patent Application JP 2007-124261 filed in the Japanese Patent Office on May 9, 2007, the entire contents of which are incorporated herein by reference.

### BACKGROUND OF THE INVENTION

1. Field of the Invention

The present invention relates to pixel circuits (hereinafter also referred to as “pixels”) and display devices. More specifically, the present invention relates to a pixel circuit including, as a display element, an electro-optical element whose luminance varies depending on the level of a drive signal, and to a display device including pixel circuits each having the above-described configuration arranged in a matrix, in which display driving is performed on a pixel-by-pixel basis by active elements provided in the respective pixel circuits.

2. Description of the Related Art

Display devices including, as display elements of pixels, electro-optical elements whose luminance varies with a voltage applied thereto or a current flowing therethrough have been available. Liquid crystal display elements are typical examples of electro-optical elements whose luminance varies with a voltage applied thereto, and organic electro-luminescent (organic light emitting (EL) diode (OLED)) elements (hereinafter referred to as “organic EL elements”) are typical examples of electro-optical element whose luminance varies with a current flowing therethrough. Organic EL display devices including the latter, organic EL elements are self-light emitting display devices including electro-optical elements, which are self-light-emitting elements, as display elements of pixels.

Display devices including electro-optical elements, such as a liquid crystal display device including liquid crystal display elements and an organic EL display device including organic EL elements, may be driven by using a simple (passive) matrix method and an active matrix method. Simple-matrix display devices are simple in structure but have problems of increased size and being difficult to realize high-definition display devices.

Recently, therefore, active-matrix display devices in which pixel signals to be supplied to light-emitting elements provided in pixels are controlled using, as switching transistors, active elements also provided in the pixels, such as insulated-gate field-effect transistors (in general, thin-film transistors (TFTs)), have been actively developed.

In order to illuminate an electro-optical element, an input image signal is fed into a pixel capacitor provided at a gate terminal (control input terminal) of a drive transistor by using a switching transistor, and a drive signal corresponding to the fed input image signal is supplied to the electro-optical element. For example, in an organic EL display device, a drive signal (voltage signal) corresponding to the input image signal is converted into a current signal by a drive transistor, and the driving current is supplied to the organic EL element.

It is important that a drive signal fed into and held in a pixel capacitor in accordance with an input image signal be constant to achieve a constant light-emission luminance of an electro-optical element. For example, in order to achieve a constant light-emission luminance of an organic EL element, it is important that a driving current corresponding to an input image signal be constant. Various configurations of pixel circuits for organic EL elements for achieving a constant driving current have been studied (see, for example, Japanese Unexamined Patent Application Publication No. 2005-345722).

Japanese Unexamined Patent Application Publication No. 2005-345722 discloses a configuration for achieving a constant driving current even if a p-channel or n-channel transistor is used as a drive transistor or even if a current-voltage characteristic of an organic EL element changes with time or there are variations or time-dependent changes in threshold voltage of the drive transistor.

### SUMMARY OF THE INVENTION

However, if leakage current of various switching transistors provided at a control input terminal of a drive transistor is large, a voltage held in a pixel capacitor varies depending on the magnitude of the leakage current. As a result, even if the configuration disclosed in Japanese Unexamined Patent Application Publication No. 2005-345722 is used, due to the change in potential caused by the leakage current of the switching transistors, the drive signal (in the disclosed example, driving current) is changed so that the light-emission luminance is not maintained at a constant level. If the occurrence levels of this phenomenon differ from pixel to pixel, an image with inconsistent quality is displayed.

It is therefore desirable to provide a configuration capable of preventing or reducing changes in drive signal level caused by leakage current of various switching transistors provided at a control input terminal of a drive transistor.

A pixel circuit according to an embodiment of the present invention includes an electro-optical element configured to emit light in response to a drive signal, a drive transistor configured to supply the drive signal to the electro-optical element, a pixel capacitor (hold capacitor) connected to a control input terminal of the drive transistor, a switching transistor provided at the control input terminal of the drive transistor, and a drive-signal stabilizing circuit configured to maintain the drive signal at a constant level.

A display device according to an embodiment of the present invention includes a plurality of pixel circuits arranged in a matrix, each pixel circuit having the configuration described above.

The drive-signal stabilizing circuit may be a circuit configured to maintain a driving current of the drive transistor at a constant level regardless of a time-dependent change in the current-voltage characteristic of the electro-optical element or a change in the characteristics of the drive transistor. The drive-signal stabilizing circuit may have any circuit configuration.

In the display device or pixel circuit according to the embodiment of the present invention, each of the drive transistor and the switching transistor provided at the control input terminal of the drive transistor has a lightly doped drain (LDD) structure. An LDD length (length of an LDD region) of the switching transistor may be set longer than an LDD length of the drive transistor.

The switching transistor provided at the control input terminal of the drive transistor may be a sampling transistor configured to selectively feed a signal in accordance with luminance information into the control input terminal of the drive transistor. In a case where a circuit configured to correct (cancel) variations in a threshold voltage of the drive transistor is provided, the switching transistor may be a detection transistor provided at the control input terminal of the drive transistor and configured to selectively detect the threshold voltage of the drive transistor.

Since the pixel circuit having the above-described configuration or the display device including pixel circuits each having the above-described configuration arranged in a matrix is provided with a drive-signal stabilizing circuit configured to maintain a drive signal at a constant level, the amount of current flowing through the electro-optical element is constant even if the current-voltage characteristic of the electro-optical element changes with time and the source potential of the drive transistor changes in accordance therewith. Therefore, light-emission luminance of the electro-optical element can also be maintained at a constant level.

In addition, since the length of the LDD region of the switching transistor in the pixel circuit is set longer than that of the LDD region of the drive transistor, the leakage current of the switching transistor can be relatively reduced.

According to an embodiment of the present invention, since the length of the LDD region of the switching transistor in the pixel circuit is set longer than that of the LDD region of the drive transistor, the leakage current due to the switching transistor can be relatively reduced to reduce the effect on a voltage held in the pixel capacitor.

Therefore, a drive signal to be supplied to the electro-optical element can be maintained at a constant level, and the light-emission luminance of the electro-optical element can be maintained at a constant level. This can prevent a reduction in image quality due to the leakage current, such as inconsistent image quality, resulting in uniform image quality.

### BRIEF DESCRIPTION OF THE DRAWINGS

FIG. 1 is a schematic block diagram showing a structure of an active-matrix display device, which may be a display device according to an embodiment of the present invention;

FIG. 2 is a diagram showing pixel circuits constituting the organic EL display device shown in FIG. 1 according to a first embodiment of the present invention;

FIG. 3 is a graph showing a time-dependent change in current-voltage characteristic of a typical organic EL element;

FIGS. 4A and 4B are diagrams showing a difference in structure between a drive transistor and a sampling transistor or a detection transistor;

FIG. 5 is a diagram showing current-voltage characteristics of the drive transistor and the sampling transistor;

FIG. 6 is a diagram showing pixel circuits constituting the organic EL display device shown in FIG. 1 according to a second embodiment of the present invention;

FIG. 7 is a diagram showing a comparative example for comparison with the pixel circuits of the second embodiment shown in FIG. 6;

FIG. 8 is a timing chart showing the overview of the operation of each of the pixel circuits of the second embodiment;

FIG. 9 is an equivalent circuit diagram showing the operation of each of the pixel circuits of the second embodiment before time T21;

FIG. 10 is an equivalent circuit diagram showing and the operation of each of the pixel circuits of the second embodiment during a period from time T21 to time T22;

FIG. 11 is an equivalent circuit diagram showing the operation of each of the pixel circuits of the second embodiment during a period from time T22 to time T23;

FIG. 12 is a diagram showing an operation characteristic of the drive transistor during a threshold-cancellation period;

FIG. 13 is an equivalent circuit diagram showing the operation of each of the pixel circuits of the second embodiment during a period from time T25 to time T26; and

FIG. 14 is an equivalent circuit diagram showing the operation of each of the pixel circuits of the second embodiment after time T27.

### DESCRIPTION OF THE PREFERRED EMBODIMENTS

Embodiments of the present invention will be described in detail with reference to the drawings.

### Overview of Display Device

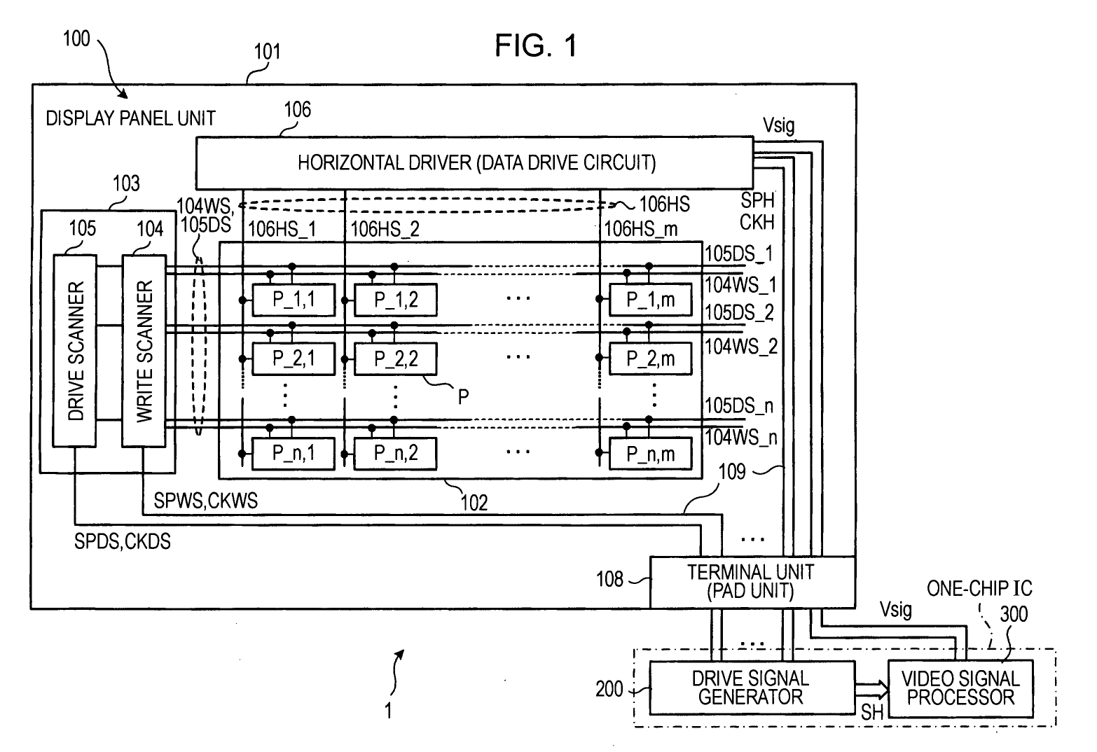

FIG. 1 is a schematic block diagram showing a structure of an active-matrix display device, which may be a display device according to an embodiment of the present invention. The embodiment will be described in the context of an active-matrix organic EL display (hereinafter referred to as an “organic EL display device”) including organic EL elements as display elements of pixels and polysilicon thin-film transistors (TFTs) as active elements, in which the organic EL elements are formed on a semiconductor substrate on which the TFTs are formed, by way of example.

Referring to FIG. 1, an organic EL display device 1 includes a display panel unit 100. The display panel unit 100 includes pixel circuits (hereinafter also referred to as “pixels”) P having a plurality of organic EL elements (not shown) as display elements so that the pixel circuits P are arranged to form an effective video region with a width-to-height ratio or display aspect ratio of X:Y (e.g., 9:16). The organic EL display device 1 further includes a drive signal generator 200, which may be an example of a panel controller configured to emit various pulse signals for controlling driving of the display panel unit 100, and a video signal processor 300. The drive signal generator 200 and the video signal processor 300 are accommodated in a one-chip integrated circuit (IC) (semiconductor integrated circuit).

The display panel unit 100 includes a pixel array unit 102 in which the pixel circuits P are arranged in a matrix of n rows and m columns, a write scanner (WS) 104 and a drive scanner (DS) 105, which are operable to vertically scan the pixel circuits P, a horizontal driver (also referred to as a “horizontal selector” or a “data line driver”) 106 configured to horizontally scan the pixel circuits P, and a terminal unit (pad unit) 108 for external connection so that the pixel array unit 102, the write scanner 104, the drive scanner 105, the horizontal driver 106, and the terminal unit 108 are formed on a substrate 101 in an integrated manner. That is, peripheral drive circuits such as the write scanner 104, the drive scanner 105 (the write scanner 104 and the drive scanner 105 being hereinafter also collectively referred to as a “vertical driver 103”) and the horizontal driver 106 are formed on the substrate 101 on which the pixel array unit 102 is formed.

As an example, the pixel array unit 102 is driven from either the right or left side, as viewed in FIG. 1, or both, by the write scanner 104 and the drive scanner 105, and is driven from either the upper or lower side, as viewed in FIG. 1, or both, by the horizontal driver 106.

The terminal unit 108 is supplied with various pulse signals from the drive signal generator 200 located outside the organic EL display device 1. The terminal unit 108 is also supplied with a video signal Vsig from the video signal processor 300.

The terminal unit 108 is supplied with necessary pulse signals as pulse signals for vertical drive, such as shift start pulses SPDS and SPWS, which may be examples of pulses for starting writing in the vertical direction, and vertical scanning clocks CKDS and CKWS. The terminal unit 108 is also supplied with necessary pulse signals as pulse signals for horizontal drive, such as a horizontal start pulse signal SPH, which may be an example of a pulse signal for starting writing in the horizontal direction, and a horizontal scan clock signal CKH.

The terminal unit 108 includes terminals connected to the write scanner 104, the drive scanner 105, and the horizontal driver 106 via wiring lines 109. For example, pulses supplied to the terminal unit 108 are used to internally adjust voltage levels by a level shifter (not shown), as necessary, and are then supplied to the write scanner 104, the drive scanner 105, and the horizontal driver 106 via buffers. The write scanner 104 and the drive scanner 105 scan the pixel array unit 102 in a line-sequential manner and, synchronously therewith, the horizontal driver 106 writes image signals to the pixel array unit 102.

The pixel array unit 102 has a structure in which the pixel circuits P, each having a pixel transistor provided for an organic EL element serving as a display element, are two-dimensionally arranged in a matrix, which is not shown in FIG. 1 (the details of which are described below), and a scanning line and a signal line are provided for every row and column of the array of pixels, respectively.

For example, scanning lines (gate lines) 104WS and 105DS and signal lines (data lines) 106HS are formed on the pixel array unit 102. Organic EL elements and thin-film transistors (TFTs) configured to drive the organic EL elements, which are not shown in FIG. 1, are formed at intersections between the scan lines 104WS and 105DS and the signal lines 106HS. The organic EL elements and the thin-film transistor are combined to form the pixel circuits P.

Specifically, in the pixel circuits P arranged in a matrix, write-scan lines 104WS_1 to 104WS_n corresponding to the n rows, which are driven in response to a write-drive pulse WS by the write scanner 104, and drive-scan lines 105DS_1 to 105DS_n corresponding to the n rows, which are driven in response to a scan-drive pulse DS by the drive scanner 105, are provided for the respective pixel rows. Signal lines (data lines) 106HS_1 to 106HS_m corresponding to the m columns, which are driven by the horizontal driver 106 and which are supplied with a signal corresponding to luminance information, are provided for the respective pixel columns.

The write scanner 104 and the drive scanner 105 sequentially select the pixel circuits P through the scan lines 105DS and 104WS on the basis of the pulse signal for vertical drive, which is supplied from the drive signal generator 200. The horizontal driver 106 writes an image signal to the selected pixel circuits P on the basis of the pulse signal for horizontal drive, which is supplied from the drive signal generator 200, through the signal lines 106HS.

The horizontal driver 106 includes shift registers and sampling switches (horizontal switches), and writes video signals to pixel circuits P in a row selected by the write scanner 104 and the drive scanner 105 on a pixel-by-pixel basis. In this embodiment, therefore, dot-sequential driving is performed in which video signals are written to pixel circuits P in a row selected by vertical scanning on a pixel-by-pixel basis. Instead of dot-sequential driving in which image signals are horizontally written to one horizontal line of pixels in sequence (that is, on a pixel-by-pixel basis), line-sequential driving in which image signals are simultaneously written to one horizontal line of pixels may be performed.

The write scanner 104 and the drive scanner 105 are formed by combining logical gates (including latches), and select the pixel circuits P of the pixel array unit 102 on a row-by-row basis. While FIG. 1 shows a structure in which the write scanner 104 and the drive scanner 105 are placed at one side of the pixel array unit 102, the write scanner 104 and the drive scanner 105 may be placed at each of the right and left sides with the pixel array unit 102 therebetween.

Likewise, while FIG. 1 shows a structure in which the horizontal driver 106 is placed at one side of the pixel array unit 102, the horizontal driver 106 may be placed at each of the upper and lower sides with the pixel array unit 102 therebetween.

### Pixel Circuit of First Embodiment

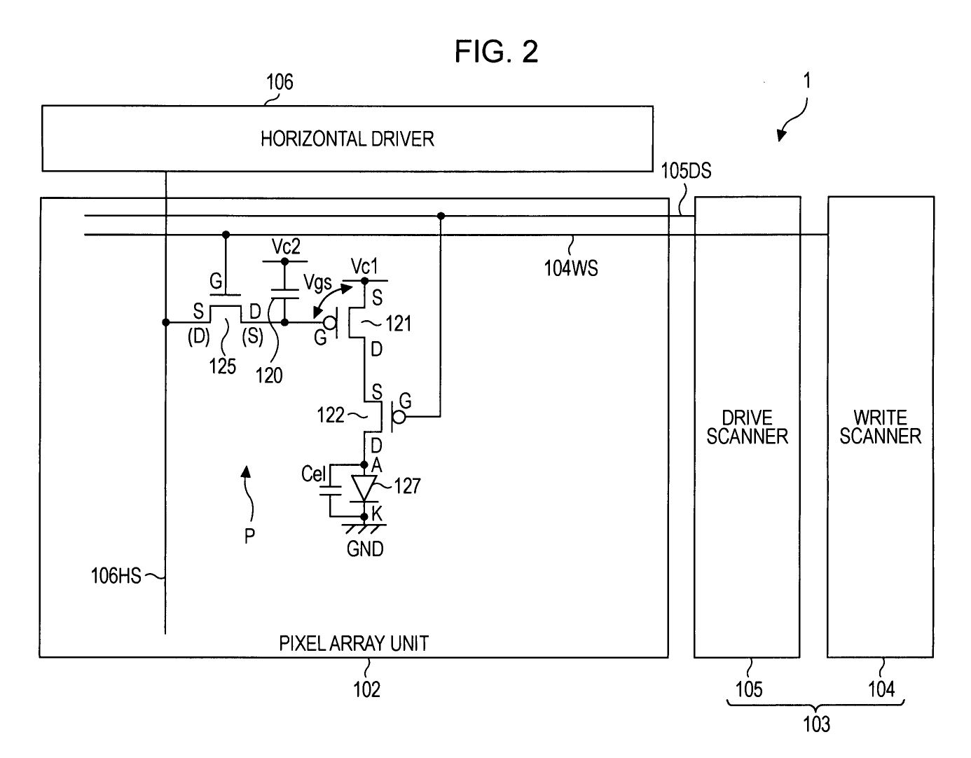

FIG. 2 is a diagram showing the pixel circuits P constituting the organic EL display device 1 shown in FIG. 1 according to a first embodiment of the present invention. FIG. 2 also shows the vertical driver 103 and the horizontal driver 106, which are provided in a peripheral portion of the pixel circuits P on the substrate 101 of the display panel unit 100.

As shown in FIG. 2, each of the pixel circuits P of the first embodiment is configured such that a drive transistor is basically formed of a p-channel thin-film field-effect transistor (TFT). Furthermore, the pixel circuit P has a three-transistor-drive structure in which two transistors for scanning are used in addition to the drive transistor.

Specifically, the pixel circuit P of the first embodiment includes a p-channel drive transistor 121, a p-channel light-emission control transistor 122 to which an active-low drive pulse is supplied, an n-channel sampling transistor 125 to which an active-high drive pulse is supplied, an organic EL element 127, which may be an example of an electro-optical element (light-emitting element) that emits light by flowing a current therethrough, and a hold capacitor (also referred to as a “pixel capacitor”) 120. The drive transistor 121 supplies a driving current corresponding to a potential supplied to a gate terminal G thereof, which may be a control input terminal, to the organic EL element 127.

Although the sampling transistor 125 is generally replaceable by a p-channel transistor to which an active-low drive pulse is supplied, this is not used in the first embodiment. Although the light-emission control transistor 122 is replaceable by an n-channel transistor to which an active-high drive pulse is supplied, this is not used in the first embodiment.

The sampling transistor 125 may be a switching transistor provided at the gate terminal G (control input terminal) of the drive transistor 121, and the light-emission control transistor 122 may also be a switching transistor.

In general, the organic EL element 127 has rectifying properties and is represented by a diode symbol. The organic EL element 127 has a parasitic capacitor Cel. In FIG. 2, the parasitic capacitor Cel is shown in parallel to the organic EL element 127.

The pixel circuit P is provided at an intersection between a corresponding one of the scan lines 105DS, a corresponding one of the scan lines 105DS, and a corresponding one of the signal lines 106HS. The write-scan line 104WS extending from the write scanner 104 is connected to a gate terminal G of the sampling transistor 125, and the drive-scan line 105DS extending from the drive scanner 105 is connected to a gate terminal G of the light-emission control transistor 122.

The sampling transistor 125 has a source terminal S that serves as a signal input terminal and that is connected to the video signal line 106HS, and a drain terminal D that serves as a signal output terminal and that is connected to the gate terminal G of the drive transistor 121. The hold capacitor 120 is provided between a node of the drain terminal D of the sampling transistor 125 and the gate terminal G of the drive transistor 121 and a second power supply potential Vc2 (for example, a positive power supply potential, which may be a first power supply potential Vc1). As indicated by parentheses, the source terminal S and the drain terminal D of the sampling transistor 125 may be replaced so that the drain terminal D serves as a signal input terminal and is connected to the video signal line 106HS and the source terminal S serves as a signal output terminal and is connected to the gate terminal G of the drive transistor 121.

The drive transistor 121, the light-emission control transistor 122, and the organic EL element 127 are connected in series in the stated order between the first power supply potential Vc1 (for example, a positive power supply voltage) and a ground potential GND, which may be an example of a reference potential. Specifically, the drive transistor 121 has a source terminal S connected to the first power supply potential Vc1, and a drain terminal D connected to a source terminal S of the light-emission control transistor 122. A drain terminal D of the light-emission control transistor 122 is connected to an anode terminal A of the organic EL element 127, and a cathode terminal K of the organic EL element 127 is connected to the ground potential GND.

In the structure of the organic EL display device 1 shown in FIG. 1, the vertical driver 103 includes two scanning circuits, namely, the write scanner 104 and the drive scanner 105. In a simpler structure, the drive scanner 105 may be removed. In this case, as the simplest circuit structure, the pixel circuit P shown in FIG. 2 has a two-transistor-drive structure in which the light-emission control transistor 122 is not used.

In either the three-transistor-drive structure shown in FIG. 2 or the two-transistor-drive structure (not shown), the organic EL element 127 is a current-dependent light-emitting element, and controls the amount of current flowing through the organic EL element 127 to obtain a gradation level of a color of emitted light. Thus, a voltage to be applied to the gate terminal G of the drive transistor 121 is changed to control the value of current flowing through the organic EL element 127.

Specifically, first, an active-high write-drive pulse WS is supplied from the write scanner 104 to set the write-scan line 104WS to a selection state, and a pixel signal Vsig is applied to the signal line 106HS from the horizontal driver 106. This brings the n-channel sampling transistor 125 into conduction so that the pixel signal Vsig is written in the hold capacitor 120.

The potential of the signal written in the hold capacitor 120 becomes the potential of the gate terminal G of the drive transistor 121. Then, the write-drive pulse WS is set inactive (in the first embodiment, low level) to set the write-scan line 104WS to a non-selection state. Thus, the signal line 106HS and the drive transistor 121 are electrically separated; however, in principle, a gate-to-source voltage Vgs of the drive transistor 121 is stably maintained by the hold capacitor 120.

Then, an active-low scan-drive pulse DS is supplied from the drive scanner 105 to set the drive-scan line 105DS to a selection state. This brings the p-channel light-emission control transistor 122 into conduction so that a driving current flows from the first power supply potential Vc1 to the ground potential GND through the drive transistor 121, the light-emission control transistor 122, and the organic EL element 127.

Then, the scan-drive pulse DS is set inactive (in the first embodiment, high level) to set the drive-scan line 105DS to a non-selection state. Thus, the light-emission control transistor 122 is turned off and no driving current flows therethrough.

The light-emission control transistor 122 is inserted to control a light-emission time (light-emission duty) of the organic EL element 127 within a period of one field. As is anticipated from the foregoing description, the pixel circuit P may not include the light-emission control transistor 122.

The current flowing through the drive transistor 121 and the organic EL element 127 has a value corresponding to the gate-to-source voltage Vgs of the drive transistor 121, and the organic EL element 127 continuously emits light with a luminance corresponding to the value of the current.

The operation of selecting the write-scan line 104WS to transmit the pixel signal Vsig applied to the signal line 106HS to the inside of the pixel circuit P is hereinafter referred to as “write”. Once a write of the signal is performed, the organic EL element 127 continuously emits light with a constant luminance until another write is performed.

In the pixel circuit P of the first embodiment, therefore, a voltage applied to the gate terminal G of the drive transistor 121 is changed in accordance with an input signal (pixel signal Vsig) to control the value of current flowing through the EL organic EL element 127. The source terminal S of the p-channel drive transistor 121 is connected to the first power supply potential Vc1, and the drive transistor 121 operates in a saturation region.

The drive transistor 121 is a constant-current source having a value given by equation (1) as follows:

$$Ids = \frac{1}{2} μ \frac{W}{L} {Cox ( Vgs - Vth )}^{2} \qquad ( 1 )$$

where Ids denotes a current flowing between a drain terminal and source terminal of a transistor operating in a saturation region, μ denotes a mobility, W denotes a channel width, L denotes a channel length, Cox denotes a gate capacitance per unit area, and Vth denotes a threshold voltage of the transistor. As is apparent from equation (1), in the saturation region, the drain current Ids of the transistor is controlled according to the gate-to-source voltage Vgs.

### I-V Characteristic of Organic EL Element

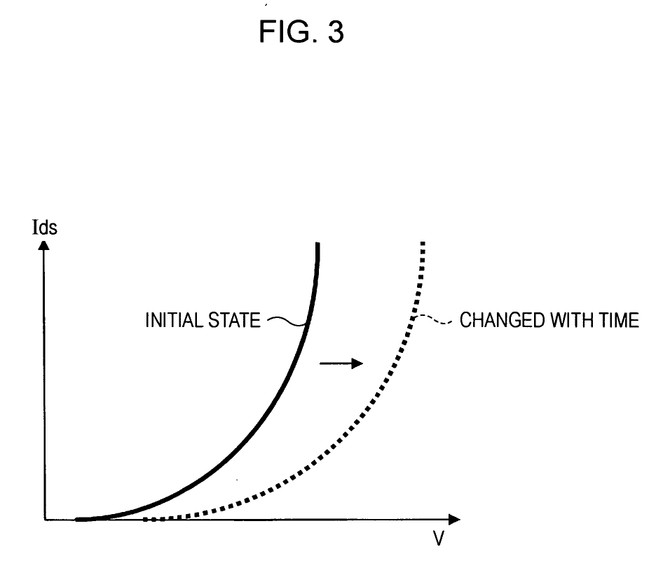

FIG. 3 is a graph showing a time-dependent change in current-voltage (I-V) characteristic of a typical optical organic EL element. In FIG. 3, a solid curve indicates the characteristic in an initial state, and a broken curve indicates the characteristic that has changed with time. As shown in the graph of FIG. 3, the I-V characteristic of an organic EL element generally deteriorates over time.

In the pixel circuit P shown in FIG. 2, on the other hand, since the drive transistor 121 is a constant-current driver, the current Ids, which is a constant current, continuously flows through the organic EL element 127. Thus, the light-emission luminance of the organic EL element 127 does not deteriorate with time even if the I-V characteristic of the organic EL element 127 deteriorates.

A structure of the pixel circuit P including the drive transistor 121, the light-emission control transistor 122, the hold capacitor 120, and the sampling transistor 125, which are connected in the manner shown in FIG. 2, constitutes a drive-signal stabilizing circuit configured to correct a change in the current-voltage characteristic of the organic EL element 127, which may be an example of an electro-optical element, to maintain the driving current at a constant level.

That is, the p-channel drive transistor 121 is designed so as to constantly operate in a saturation region because the source terminal S of the p-channel drive transistor 121 is connected to the first power supply potential Vc1 when the pixel circuit P is driven by the pixel signal Vsig. The p-channel drive transistor 121 is therefore a constant-current source having the value given by equation (1).

In such a circuit, the voltage of the drain terminal D of the drive transistor 121 changes in accordance with a time-dependent change (see FIG. 3) in the I-V characteristic of the organic EL element 127. In principle, however, the gate-to-source voltage Vgs of the drive transistor 121 is maintained at a constant level by the hold capacitor 120, and the drive transistor 121 operates as a constant-current source. As a result, a constant amount of current flows through the organic EL element 127 to allow the organic EL element 127 to emit light with a constant luminance. No change occurs in the light-emission luminance.

### Voltage Held in Hold Capacitor

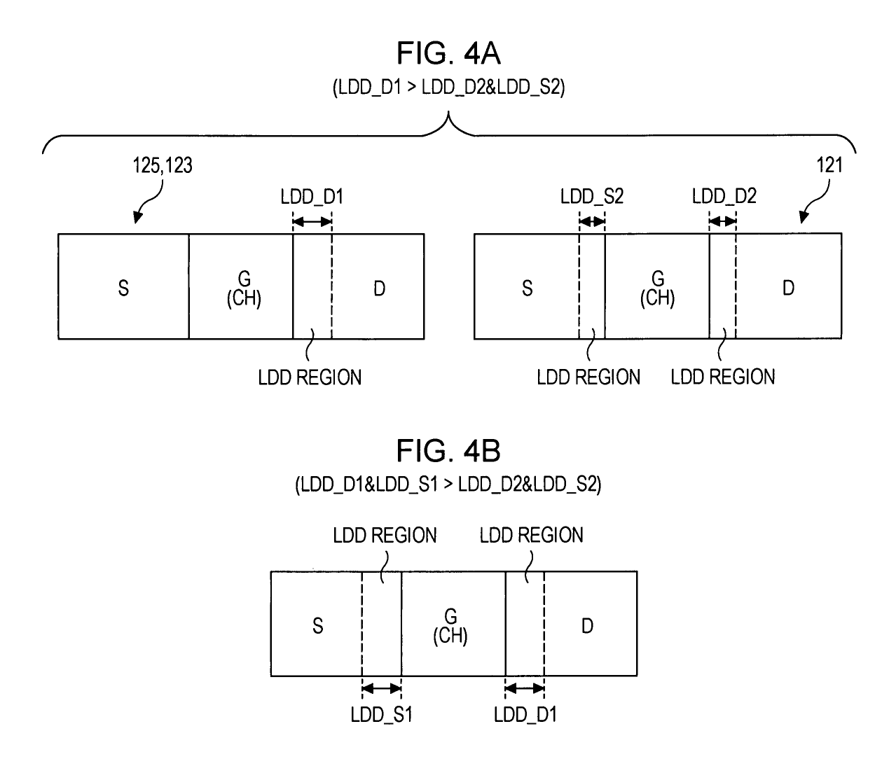

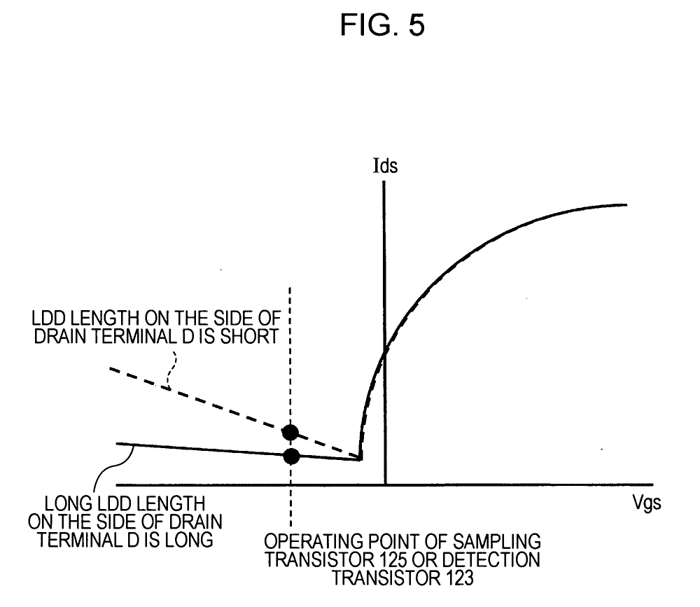

FIGS. 4A to 5 are diagrams showing the operation of the drive transistor 121 and the sampling transistor 125, which may be an example of a switching transistor, according to the first embodiment. FIGS. 4A and 4B are diagrams showing a difference in structure between the drive transistor 121 and the sampling transistor 125, and FIG. 5 is a diagram showing current-voltage (I-V) characteristics of the drive transistor 121 and the sampling transistor 125. A detection transistor 123 used in a second embodiment of the present invention, which will be described below, also has a structure similar to the sampling transistor 125.

In the foregoing description, when the write-drive pulse WS is set inactive to set the write-scan line 104WS to a non-selection state, the gate-to-source voltage Vgs of the drive transistor 121 is stably held in the hold capacitor 120 in principle. As a result, even if the write-drive pulse WS is set inactive, the drive transistor 121 continues its constant-current operation to allow the organic EL element 127 to continuously emit light with a constant luminance.

This means that the performance of holding the gate-to-source voltage Vgs of the drive transistor 121 in the hold capacitor 120 affects the performance that allows the organic EL element 127 to continuously emit light with a constant luminance.

### Operation and Characteristics of Sampling Transistor of First Embodiment

The operation and characteristics of the sampling transistor 125 for signal writing, which is provided in the pixel circuit P, will now be discussed. If leakage current of the sampling transistor 125 is large during the light-emission time of the organic EL element 127, the voltage held in the hold capacitor 120 varies depending on the level of the leakage current.

As a result, due to the leakage current of the sampling transistor 125, the performance of holding the gate-to-source voltage Vgs of the drive transistor 121 deteriorates to prevent the organic EL element 127 from continuously emitting light with a constant luminance. This results in a displayed image with inconsistent quality.

As the value of the hold capacitor 120 increases, the amount of change in the gate-to-source voltage Vgs due to the leakage current is reduced. However, the amount of change is not usually reduced to zero, and the problem of inconsistent quality caused by the leakage current still remains to some extent.

In the first embodiment, therefore, in order to reduce the leakage current of the sampling transistor 125, first, the drive transistor 121 and the sampling transistor 125 are implemented by n-channel transistors and have a lightly doped drain (LDD) structure. The remaining, p-channel transistors may have a single drain (SD) structure. Preferably, the remaining, p-channel transistors also have an LDD structure.

For example, as shown in FIG. 4, a channel region CH corresponding to a gate is provided in a center portion of a polycrystalline silicon (Poly-Si) thin-film semiconductor layer having a predetermined shape, and an LDD region doped with a low-concentration n-impurity such as phosphorus (P) is provided in a junction on one side (see FIG. 4A) of the channel region CH or both sides (see FIG. 4B). On the outside of the LDD region, a source region S and drain region D doped with a high-concentration n-impurity such as arsenic (As) are provided. That is, an LDD region with a lower impurity concentration than the source region S or the drain region D is provided in a junction between the source region S or the drain region D and the channel region CH. In general, the LDD region is provided to prevent electrical leakage of TFTs.

An LDD region of a transistor generally functions to reduce, when, in particular, added to a drain terminal D thereof, the electric field concentration to the drain terminal D. As an LDD length on the side of a drain terminal D increases, as shown in FIG. 5, an Iback characteristic of a transistor decreases. Conversely, as the LDD length decreases, the Iback characteristic increases.

As shown in FIG. 5, an operating point of the sampling transistor 125 in occurrence of leakage is at a predetermined potential of the negative voltage side with respect to the gate-to-source voltage Vgs of the drive transistor 121. Thus, a length (LDD_D1) of an LDD region in a portion with large variations in image quality (inconsistent quality) caused by the leakage current, or an LDD region on the side of the drain terminal D of the sampling transistor 125 in the pixel circuit P, is set longer than an LDD length LDD_D2 of the drain terminal of the drive transistor 121 or a LDD length LDD_S2 of the source terminal of the drive transistor 121.

The drive transistor 121 is not a switch or is not turned off unlike the sampling transistor 125, and an LDD region is generally added to only a drain side in the manner shown in FIG. 4A. Thus, in general, only the LDD length LDD_D2 of the drain terminal of the drive transistor 121 may be taken into account. In some cases, however, as shown in FIG. 4B, an LDD region may also be provided on a source side in view of symmetry or the like. In those cases, both the LDD length LDD_D2 of the drain terminal and the LDD length LDD_S2 of the source terminal of the drive transistor 121 meet the conditions described above.

Setting an LDD length longer than the LDD length of the drive transistor 121 may be realized by, for example, adjustment based on a TFT mask or the like.

Accordingly, the LDD length of the sampling transistor 125 is set longer than the LDD length of the drive transistor 121, whereby the leakage current of the sampling transistor 125 can be relatively reduced with respect to the drive transistor 121. This results in a reduction in variations in voltage held in the hold capacitor 120 due to the leakage current of the sampling transistor 125, and a reduction in variations in image quality due to the leakage current of the sampling transistor 125. Therefore, uniform image quality can be obtained compared with a case where the first embodiment is not used.

### Pixel Circuit of Second Embodiment

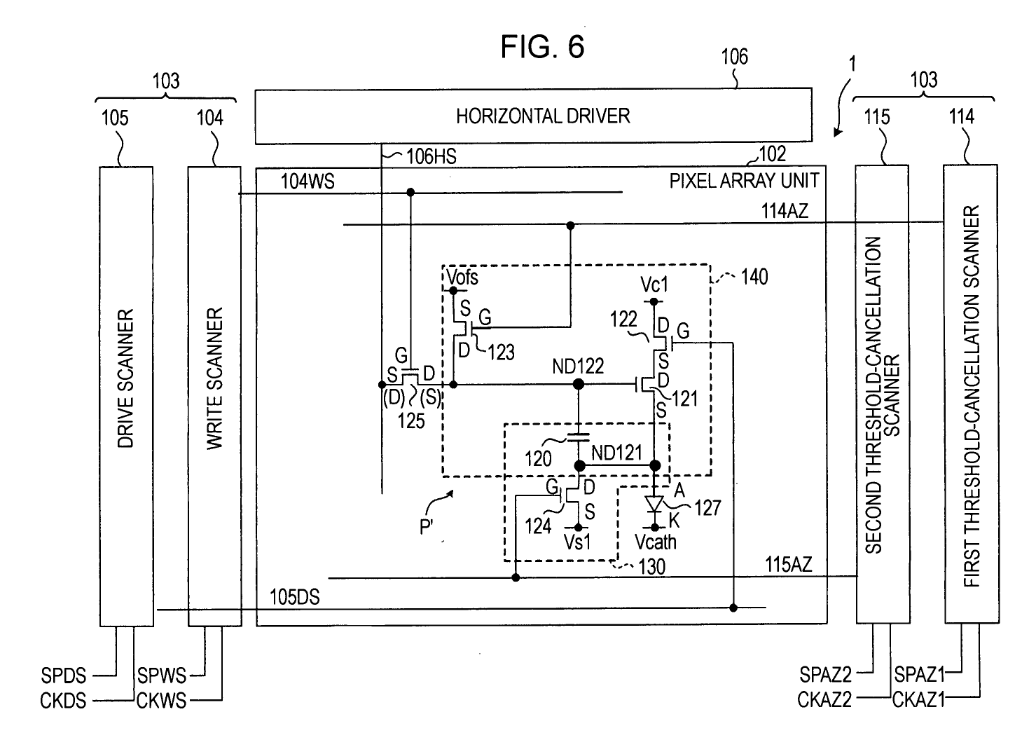

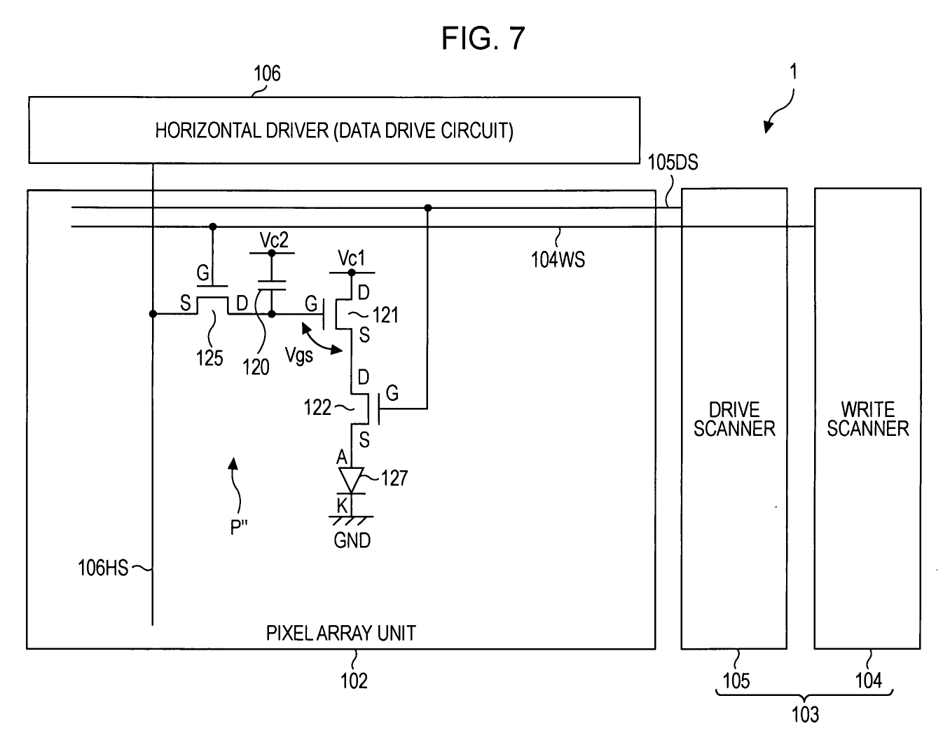

FIG. 6 is a diagram showing pixel circuits P constituting the organic EL display device 1 shown in FIG. 1 according to a second embodiment of the present invention (hereinafter referred to as “pixel circuits P′”). FIG. 7 is a diagram showing pixel circuits P″ of a comparative example for comparison with the pixel circuits P′ of the second embodiment shown in FIG. 6. FIGS. 6 and 7 also show the vertical driver 103 and the horizontal driver 106, which are provided in a portion peripheral to the pixel circuits P′ and P″ on the substrate 101 of the display panel unit 100.

Each of the pixel circuits P′ of the second embodiment is configured such that a drive transistor is basically formed of an n-channel thin-film field-effect transistor. Furthermore, the pixel circuit P′ of the second embodiment has a five-transistor-drive structure in which, in addition to the drive transistor, two transistors for scanning are used and two transistors are used to prevent the effect on the driving current Ids due to the time-dependent deterioration in the organic EL element 127 or variations in the characteristics of the drive transistor 121. The pixel circuit P′ therefore includes a circuit configured to reduce a change in the driving current Ids flowing through the organic EL element 127 due to time-dependent deterioration in the organic EL element 127 or variations in the characteristics of the drive transistor 121. That is, the pixel circuit P′ includes a drive-signal stabilizing circuit configured to maintain the driving current Ids at a constant level.

In the pixel circuit P of the first embodiment, the drive transistor 121 is a p-channel transistor. In the pixel circuit P′ of the second embodiment, on the other hand, the drive transistor 121 may be formed of an n-channel transistor, whereby transistors can be produced using an existing amorphous silicon (a-Si) process. Thus, the cost of a transistor substrate can be reduced, and the development of the pixel circuit P′ having the configuration described above is expected.

### Pixel Circuit of Comparative Example

Before describing the advantages of the pixel circuit P′ of the second embodiment, first, the pixel circuits P″ shown in FIG. 7 will be described as a comparative example. Each of the pixel circuits P″ of the comparative example is basically the same as the pixel circuit P′ of the second embodiment in that a drive transistor is an n-channel thin-film field-effect transistor. However, the pixel circuit P″ of the comparative example does not include a drive-signal stabilizing circuit configured to prevent the effect on the driving current Ids due to the time-dependent deterioration in the organic EL element 127.

Specifically, the pixel circuit P″ includes an n-channel drive transistor 121, a light-emission control transistor 122, and a sampling transistor 125.

The drive transistor 121 has a drain terminal D connected to a first power supply potential Vc1, and a source terminal S connected to a drain terminal D of the light-emission control transistor 122. A source terminal S of the light-emission control transistor 122 is connected to an anode terminal A of the organic EL element 127, and a cathode terminal K of the organic EL element 127 is connected to a ground potential GND. In the pixel circuit P″ having the configuration described above, the drain terminal D of the drive transistor 121 is connected to the first power supply potential Vc1, and the source terminal S thereof is connected to the anode terminal A of the organic EL element 127. Thus, a source-follower circuit is formed as a whole.

In the pixel circuit P″ of the comparative example, a potential of the source terminal S of the drive transistor 121 is determined by the operating point of the drive transistor 121 and the organic EL element 127, and a voltage value thereof has different values depending on a gate voltage. Since the drive transistor 121 is driven in a saturation region, for a gate-to-source voltage Vgs corresponding to a source voltage at the operating point, a driving current Ids having the current value given by equation (1) is caused to flow.

However, the I-V characteristic of the organic EL element 127 deteriorates with time in the manner described above with reference to FIG. 3. Due to this time-dependent deterioration, the operating point changes, and a source voltage of the drive transistor 121 changes even if an identical gate voltage Vg is applied. This causes a change in the gate-to-source voltage Vgs of the drive transistor 121 to change the value of current flowing therethrough, and also causes a change in the value of current flowing through the organic EL element 127. Therefore, in accordance with a change in the I-V characteristic of the organic EL element 127, the light-emission luminance of the organic EL element 127 of the pixel circuit P″ of the comparative example having the source-follower structure shown in FIG. 7 changes with time.

Accordingly, if the drive transistor 121 is implemented by an n-channel transistor, in place of a p-channel transistor, without changing its configuration, the source terminal S of the drive transistor 121 is connected to the organic EL element 127, resulting in a change in the gate-to-source voltage Vgs in accordance with a time-dependent change in the organic EL element 127. Thus, the amount of current flowing through the organic EL element 127 changes to cause a change in the light-emission luminance.

In the first embodiment, the characteristics of the drive transistor 121 are not particularly focused on. However, if the characteristics of the drive transistor 121 differ from pixel to pixel, the difference in the characteristics affects the current Ids flowing through the drive transistor 121. As an example, as can be seen from equation (1), a variation in the mobility μ or the threshold voltage Vth depending on the pixel or a change in the mobility μ or the threshold voltage Vth over time causes a variation or time-dependent change in the current Ids flowing through the drive transistor 121 even if the gate-to-source voltage Vgs is the same. Thus, the light-emission luminance of the organic EL element 127 also varies from pixel to pixel.

### Pixel Circuit of Second Embodiment

The pixel circuit P′ of the second embodiment shown in FIG. 6 is provided with a circuit configured to prevent such problems with the pixel circuit P″ of the comparative example shown in FIG. 7, that is, time-dependent deterioration in the organic EL element 127 and a change in the driving current due to variations in the characteristics of the drive transistor 121.

The pixel circuit P′ of the second embodiment is advantageous over the pixel circuit P″ of the comparative example shown in FIG. 7 in that: the drive transistor 121 and the light-emission control transistor 122 are arranged in reverse order; a hold capacitor 120 is connected between a gate and source of the drive transistor 12; and the pixel circuit P′ of the second embodiment further includes a bootstrap circuit 130 and a threshold-voltage cancellation circuit 140.

The vertical driver 103 configured to drive the pixel circuit P′ includes, in addition to the write scanner 104 and the drive scanner 105, two threshold-cancellation scanners 114 and 115. The threshold-cancellation scanners 114 and 115 are supplied with necessary pulse signals as pulse signals for vertical drive, such as shift start pulses SPAZ1 and SPAZ2, which may be examples of pulses for starting detection of a threshold value in the vertical direction, and vertical scanning clocks CKAZ1 and CKAZ2, from the drive signal generator 200 (see FIG. 1), which is not shown in FIG. 6.

Although FIG. 6 shows only one pixel circuit P′, as shown in FIG. 1, pixel circuits P′ having a similar structure are arranged in a matrix. In the pixel circuits P′ arranged in a matrix, in addition to write-scan lines 104WS_1 to 104WS_n corresponding to the n rows, which are driven in response to a write-drive pulse WS by the write scanner 104, and drive-scan lines 105DS_1 to 105DS_n corresponding to the n rows, which are driven in response to a scan-drive pulse DS by the drive scanner 105, threshold-cancellation scan lines 114AZ_1 to 114AZ_n corresponding to the n rows, which are driven in response to a threshold-cancellation pulse AZ1 by the first threshold-cancellation scanner 114, and threshold-cancellation scan lines 115AZ_1 to 115AZ_n corresponding to the n rows, which are driven in response to a threshold-cancellation pulse AZ2 by the second threshold-cancellation scanner 115, are provided for the respective pixel rows.

The bootstrap circuit 130 includes an n-channel detection transistor 124 connected in parallel to the organic EL element 127. The detection transistor 124 and the hold capacitor 120 connected the gate and source of the drive transistor 121 constitute the bootstrap circuit 130. The hold capacitor 120 also serves as a bootstrap capacitor.

The threshold-voltage cancellation circuit 140 includes an n-channel detection transistor 123 between the gate terminal G of the drive transistor 121 and a second power supply potential Vc2. The detection transistor 123, the drive transistor 121, the light-emission control transistor 122, and the hold capacitor 120 connected between the gate and source of the drive transistor 121 constitute the threshold-voltage cancellation circuit 140. The hold capacitor 120 also serves as a threshold-voltage hold capacitor configured to hold the detected threshold voltage Vth.

The detection transistor 123 may be a switching transistor provided at the gate terminal G (control input terminal) of the drive transistor 121. The detection transistor 123 has a source terminal S connected to a ground potential Vofs, a drain terminal D connected to the gate of the drive transistor 121 (a node ND122), and a gate terminal G connected to the threshold-cancellation scan line 114AZ.

The hold capacitor 120 has a first terminal connected to the source terminal S of the drive transistor 121, and a second terminal connected to the gate terminal G of the drive transistor 121. In FIG. 6, the source terminal of the drive transistor 121 is represented by a node ND121 and the gate terminal G of the drive transistor 121 is represented by a node ND122. The hold capacitor 120 is therefore connected between the nodes ND121 and ND122.

The drain terminal D of the drive transistor 121 is connected to a source terminal S of the light-emission control transistor 122. A drain terminal D of the light-emission control transistor 122 is connected to a first power supply potential Vc1. The source terminal S of the drive transistor 121 is directly connected to an anode terminal A of the organic EL element 127. A cathode terminal K of the organic EL element 127 is connected to a cathode potential Vcath, which may be a reference potential.

The detection transistor 124 may be a switching transistor, and has a drain terminal D connected to the node ND121, which is a connection node between the source terminal S of the drive transistor 121 and the anode terminal A of the organic EL element 127, a source terminal S connected to a ground potential Vs1, which may be an example of a reference potential, and a gate terminal G connected to the threshold-cancellation scan line 115AZ.

The hold capacitor 120 is connected between the gate and source of the drive transistor 121, and the potential of the source terminal S of the drive transistor 121 is connected to a fixed potential through the detection transistor 124.

The sampling transistor 125 operates, when it is selected by the write-scan line 104WS, to sample the pixel signal Vsig from the signal line 106HS, and holds it in the hold capacitor 120 through the node ND122. The potential held in the hold capacitor 120 is referred to as a signal potential Vin.

The drive transistor 121 drives the organic EL element 127 by current according to the signal potential Vin held in the hold capacitor 120. The light-emission control transistor 122 is brought into conduction when it is selected by the drive-scan line 105DS, and supplies a current to the drive transistor 121 from the power supply potential Vc1.

When active-high threshold-cancellation pulses AZ1 and AZ2 are supplied to the threshold-cancellation scan lines 114AZ and 115AZ from the threshold-cancellation scanners 114 and 115 to set the detection transistors 123 and 124 to a selection state, respectively, the detection transistors 123 and 124 operate to detect the threshold voltage Vth of the drive transistor 121 before the organic EL element 127 is driven by current. The detected potential is held in the hold capacitor 120 to cancel the effect of the threshold voltage Vth in advance.

In order to ensure normal operation of the pixel circuit P′ having the configuration above described, the ground potential Vs1 is set lower than a level obtained by subtracting the threshold voltage Vth of the drive transistor 121 from the ground potential Vofs. That is, condition “Vs1<Vofs−Vth” is set.

Further, a level obtained by adding a threshold voltage Vthel of the organic EL element 127 to the potential Vcath of the cathode terminal K of the organic EL element 127 is set higher than the level obtained by subtracting the threshold voltage Vth of drive transistor 121 from the ground potential Vofs. That is, condition “Vcath+Vthel>Vofs−Vth” is set. Preferably, the level of the ground potential Vofs is set in the vicinity of the lowest level of the pixel signal Vsig supplied from the signal line 106HS.

### Operation of Pixel Circuit of Second Embodiment

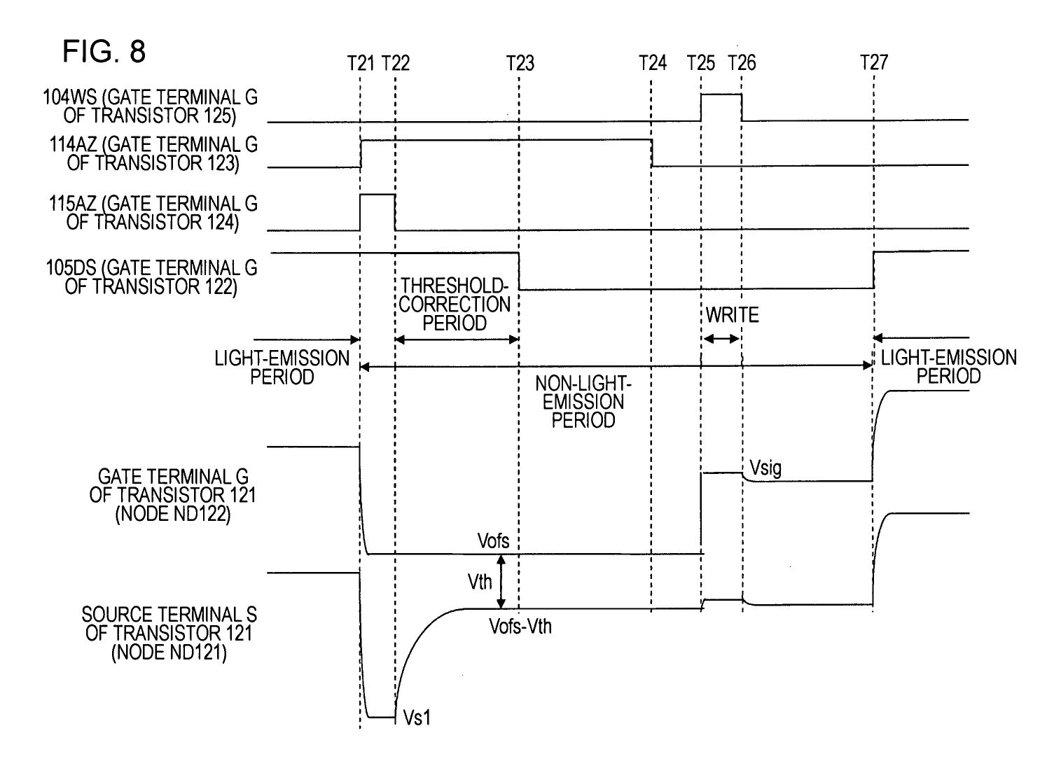

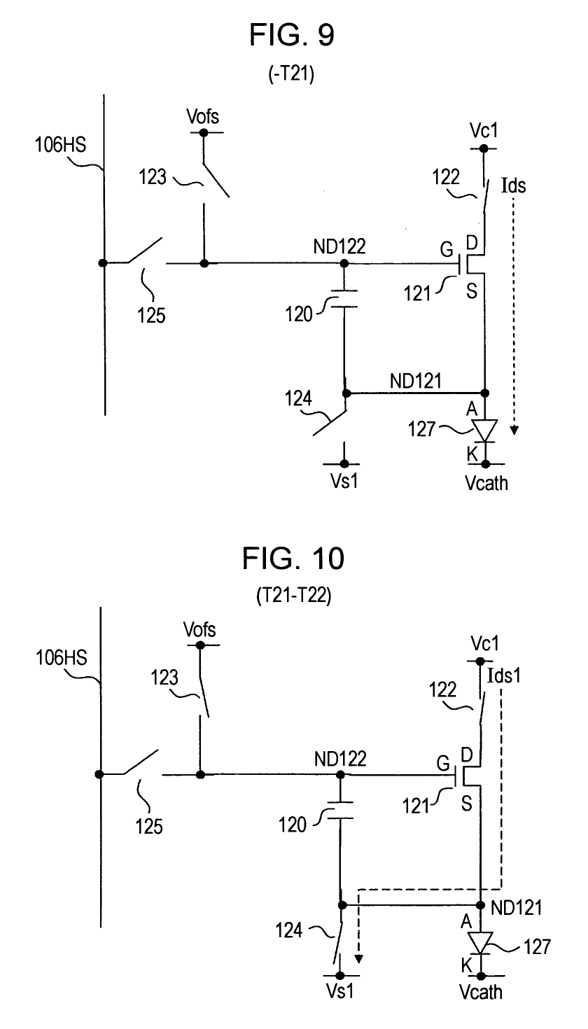

FIGS. 8 to 14 are diagrams showing the operation of the pixel circuit P′ of the second embodiment. FIG. 8 is a timing chart showing the overview of the operation of the pixel circuit P′ of the second embodiment, and FIGS. 9, 10, 11, 13, and 14 are equivalent circuit diagrams showing the operation at certain timings. FIG. 12 is a diagram showing an operation characteristic of the drive transistor 121 during a threshold-correction period.

FIG. 8 shows a timing relationship within a period of one field (1F) among a write-drive pulse WS supplied to the pixel circuit P′ (more specifically, the gate of the sampling transistor 125) from the write scanner 104 through the write-scan line 104WS when the pixel circuit P′ is driven, a threshold-cancellation pulse (auto-zero pulse) AZ1 supplied to the pixel circuit P′ (more specifically, the gate of the detection transistor 123) from the threshold-cancellation scanner 114 through the threshold-cancellation scan line 114AZ, a threshold-cancellation pulse (auto-zero pulse) AZ2 supplied to the pixel circuit P′ (more specifically, the gate of the detection transistor 124) from the threshold-cancellation scanner 115 through the threshold-cancellation scan line 115AZ, a scan driving pulse DS supplied to the pixel circuit P′ (more specifically, the gate of the light-emission control transistor 122) from the drive scanner 105 through the drive-scan line 105DS, and a gate potential Vg (potential of the node ND122) and source potential Vs (potential of the node ND121) of the drive transistor 121.

In FIGS. 9, 10, 11, 13, and 14, the transistors 122, 123, 124, and 125 are shown by using switch symbols.

In a normal light-emission state (before time T21), only the scan driving pulse DS output from the drive scanner 105 is active high, and the other pulses, namely, the write-drive pulse WS and threshold-cancellation pulses AZ1 and AZ2 output from the write scanner 104 and the threshold-cancellation scanners 114 and 115, respectively, are inactive low. Thus, only the light-emission control transistor 122 is turned on.

In this state, as shown in FIG. 9, the drive transistor 121 is set to operate in the saturation region, and the current Ids flowing through the organic EL element 127 has the value given by equation (1) in accordance with the gate-to-source voltage Vgs of the drive transistor 121. In other words, the drive transistor 121 operates as a constant-current source.

Then, when the light-emission control transistor 122 is turned on, the threshold-cancellation pulses AZ1 and AZ2 are set active high substantially at the same time. Thereby the detection transistors 123 and 124 are turned on (T21). Either the detection transistor 123 or 124 may be turned on first. This prevents current from flowing through the organic EL element 127 so that the organic EL element 127 is set to a non-light-emission state.

In this state, as shown in FIG. 10, the ground potential Vofs is supplied to the gate terminal G of the drive transistor 121 through the detection transistor 123, and the ground potential Vs1 is supplied to the source terminal S of the drive transistor 121 through the detection transistor 124. The gate-to-source voltage Vgs of the drive transistor 121 has a value given by Vofs−Vs1. However, since condition “Vs1<Vofs−Vth” is set, the drive transistor 121 is still turned on, and a corresponding current Ids1 flows.

In order to set the organic EL element 127 to a non-light-emission state, the voltages of the ground potential Vofs and the ground potential Vs1 are set so as to satisfy relation “Vcath+Vthel>Vofs−Vth”. That is, a voltage Vel (=Vofs−Vth) applied to the anode terminal A of the organic EL element 127 after the operation of correcting a threshold value is smaller than the sum of the threshold voltage Vthel of the organic EL element 127 and the cathode voltage Vcath. This causes no current to flow through the organic EL element 127 to set the organic EL element 127 to a non-light-emission state. Therefore, the drain current Ids1 of the drive transistor 121 flows from the power supply potential Vc1 to the ground potential Vs1 through the detection transistor 124, which is turned on.

Then, when the light-emission control transistor 122 and the detection transistor 123 are turned on, the threshold-cancellation pulse AZ2 is set inactive low. Thereby the detection transistor 124 is turned off and a threshold-correction period (T22) during which the threshold voltage Vth of the drive transistor 121 is corrected (canceled) arrives.

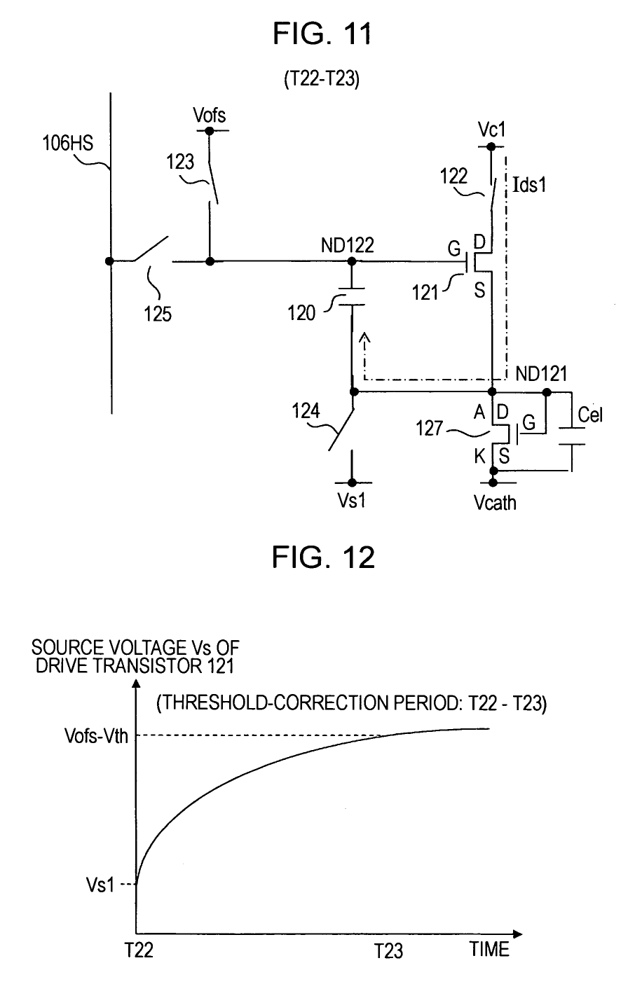

In this state, as shown in FIG. 11, the equivalent circuit of the organic EL element 127 is represented by a parallel circuit including a diode (in the structure shown in FIG. 11, the drain D and gate G of the FET are connected) and a parasitic capacitor Cel. Thus, as long as condition “Vel≦Vcath+Vthel” is satisfied, that is, as long as the leakage current of the organic EL element 127 is much smaller than the current flowing through the drive transistor 121, the current of the drive transistor 121 is used to charge the hold capacitor 120 and the parasitic capacitor Cel.

As a consequence, when the current path of the drain current Ids flowing through the drive transistor 121 is blocked, as shown in FIG. 12, the voltage Vel of the anode terminal A of the organic EL element 127, that is, the potential of the node ND121, increases with time. When the difference between the potential of the node ND121 and the potential of the node ND122 becomes equal to the threshold voltage Vth, the state of the drive transistor 121 is changed from the on state to the off state. Thus, the drain current does not flow, and the threshold-correction period ends (T23). That is, after the elapse of a certain time period, the gate-to-source voltage Vgs of the drive transistor 121 has a value of the threshold voltage Vth.

In this state, condition “Vel=Vofs−Vth≦Vcath+Vthel” is obtained. That is, the potential difference between the nodes ND121 and ND122, which is equal to the threshold voltage Vth, is held in the hold capacitor 120. Accordingly, the detection transistors 123 and 124 operate, when selected at appropriate timings by the threshold-cancellation scan lines 114AZ and 115AZ, respectively, to detect the threshold voltage Vth of the drive transistor 121, and hold it in the hold capacitor 120.

After this threshold cancellation operation ends, the scan-drive pulse DS and the threshold-cancellation pulse AZ2 are sequentially set inactive low to turn off the light-emission control transistor 122 and the detection transistor 123 in the stated order (T23 and T24). Since the light-emission control transistor 122 is turned off before the detection transistor 123 is turned off, the change in the voltage Vg of the gate terminal G of the drive transistor 121 can be suppressed.

After the elapse of the threshold cancellation (Vth correction period) between time T22 and time T23, the detected threshold voltage Vth of the drive transistor 121 is still held as a correction potential in the hold capacitor 120.

Then, the write-drive pulse WS is set active high to turn on the sampling transistor 125, and a period in which the pixel signal Vsig is written to the hold capacitor 120 arrives (T25 to T26). The pixel signal Vsig is held so as to be added to the threshold voltage Vth of the drive transistor 121. As a result, a change in the threshold voltage Vth of the drive transistor 121 is constantly canceled. Thus, threshold correction is performed.

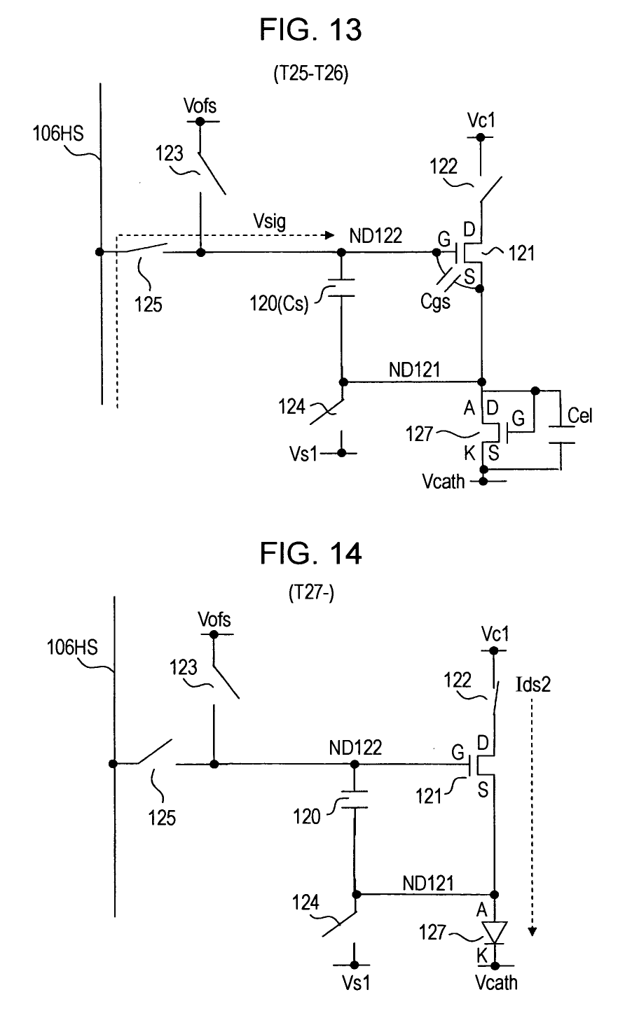

In this state, when the pixel signal Vsig is supplied to the gate terminal G of the drive transistor 121, as shown in FIG. 13, the gate voltage Vg becomes a signal voltage Vsig. The gate-to-source voltage Vgs of the drive transistor 121, that is, the input potential Vin written to the hold capacitor 120, is determined by equation (2) below by using the hold capacitor 120 (with a capacitance value Cs), a parasitic capacitor Cel (with a capacitance value Cel) of the organic EL element 127, and a parasitic capacitor (with a capacitance value Cgs) between the gate and the source:

$$Vgs = \frac{Cel}{Cel + Cs + Cgs} ( Vsig - Vofs ) + Vth \qquad ( 2 )$$

The parasitic capacitor Cel is generally much larger than the capacitance value Cs of the hold capacitor 20 and the capacitance value Cgs of the parasitic capacitor between the gate and the source. Thus, the input potential Vin written to the hold capacitor 120 is substantially equal to “Vsig−Vofs+Vth”. By setting the ground potential Vofs in the vicinity of black level (which may be a ground (GND) level) of the pixel signal Vsig, therefore, the gate-to-source voltage Vgs (equal to the input potential Vin) is substantially equal to “Vsig+Vth”.

Then, the write-drive pulse WS is set inactive low to turn off the sampling transistor 125. After the end of the write period (T26), the scan-drive pulse DS is set active high to turn on the light-emission control transistor 122 (T27). This increases the voltage of the drain terminal D of the drive transistor 121 to the power supply voltage Vc1.

In this state, the gate-to-source voltage Vgs of the drive transistor 121 is constant. Thus, as shown in FIG. 14, the drive transistor 121 causes a constant current Ids2 to flow through the organic EL element 127. As a result, a voltage drop occurs, and the potential Vel (=potential of the node ND121) of the anode terminal A of the organic EL element 127 is increased to a voltage Vx at which the current Ids2 flows through the organic EL element 127, and the organic EL element 127 emits light.

Also in the pixel circuit P′ of the second embodiment, the I-V characteristic of the organic EL element 127 changes if the light-emission time is long. The potential of the node ND121 also changes accordingly.

In the period during which the sampling transistor 125 is turned off, however, due to the effect of the hold capacitor 120 connected between the gate and source of the drive transistor 121, the potential of the node ND122 increases in accordance with an increase in the potential of the node ND121, and the gate-to-source potential Vgs of the drive transistor 121 is constantly maintained to be substantially equal to “Vsig+Vth” regardless of the increase in the potential of the node ND121. Thus, no change occurs in the current flowing through the organic EL element 127. Therefore, the constant current Ids continuously flows even if the I-V characteristic of the organic EL element 127 deteriorates, and the organic EL element 127 continuously emits light with a luminance in accordance with the pixel signal Vsig. No change occurs in the luminance.

The advantages achieved by the pixel circuit P′ having a source-follower circuit structure including the n-channel drive transistor 121, in which the hold capacitor 120 is connected between the gate and source of the drive transistor 121 and the source terminal S of the drive transistor 121 is selectively connected to a fixed potential (in this example, the ground potential Vs1) through the detection transistor 124, will be described in more detail.

In the light-emission time (after time T27) of the organic EL element 127 after the pixel signal Vsig is written to the hold capacitor 120, the detection transistor 124 is turned off to cause current to start flowing through the organic EL element 127. Due to the existence of the hold capacitor 120 between the gate terminal G and source terminal S of the drive transistor 121, the gate-to-source potential Vgs of the drive transistor 121 is constantly substantially equal to “Vsig+Vth” regardless of a change in the source potential Vs of the drive transistor 121.

Further, the drive transistor 121 operates as a constant-current source. Thus, even if the I-V characteristic of the organic EL element 127 changes with time and the source potential Vs of the drive transistor 121 changes in accordance therewith, the gate-to-source potential Vgs of the drive transistor 121 is maintained at a constant level (≅Vsig+Vth) by the hold capacitor 120. No change occurs in the current flowing through the organic EL element 127, and the light-emission luminance of the organic EL element 127 is also maintained at a constant level.

The operation for such luminance correction is hereinafter referred to as a “bootstrap operation”. The bootstrap operation would enable image display without luminance deterioration in accordance with a time-dependent change in the I-V characteristic of the organic EL element 127.

In the pixel circuit P′ of the second embodiment, therefore, the bootstrap circuit 130 serves as a drive-signal stabilizing circuit configured to correct a change in the voltage-current characteristic of the organic EL element 127, which may be an example of an electro-optical element, to maintain driving current at a constant level.

Furthermore, since the pixel circuit P′ is formed of a source-follower circuit including the n-channel drive transistor 121, the organic EL element 127 can be driven even if the organic EL element 127 is implemented by an existing organic EL element having anode and cathode electrodes without changing its configuration. In addition, peripheral transistors 122, 123, 124, and 125, as well as the drive transistor 121, may be formed of n-channel transistors to construct the pixel circuit P′, and TFTs can also be produced using an amorphous silicon (a-Si) process. Thus, the cost of a TFT substrate can be reduced.

The pixel circuit P′ of the second embodiment is further provided with the threshold-voltage cancellation circuit 140, and the operation of the detection transistors 123 and 124 during the threshold-correction period allows the threshold voltage Vth of the drive transistor 121 to be canceled and allows a constant current Ids, which is not affected by variations in the threshold voltage Vth, to flow. Thus, a high-quality image can be obtained.

Therefore, the threshold-voltage cancellation circuit 140 serves as a drive-signal stabilizing circuit configured to correct the effect of a threshold voltage to maintain a driving current at a constant level in order to prevent the effect on the driving current Ids due to variations in the characteristics of the drive transistor 121 (in this example, in particular, variations in the threshold voltage).

### Operation and Characteristics of Sampling Transistor of Second Embodiment

As in the first embodiment, the operation and characteristics of the sampling transistor 125 for signal writing, which is provided in the pixel circuit P′, will now be discussed. If leakage current of the sampling transistor 125 or the detection transistor 123 is large during the light-emission time of the organic EL element 127, the voltage held in the hold capacitor 120 varies depending on the level of the leakage current.

As a result, due to the leakage current of the sampling transistor 125 or the detection transistor 123, the performance of holding the gate-to-source voltage Vgs of the drive transistor 121 deteriorates to prevent the organic EL element 127 from continuously emitting light with a constant luminance. This results in a displayed image with inconsistent quality due to the leakage current of the sampling transistor 125 or the detection transistor 123 even if the threshold voltage Vth of the drive transistor 121 is corrected.

Inconsistent quality due to the leakage current largely depends upon the detection transistor 123 or the sampling transistor 125. The hold capacitor (pixel capacitor) 120 and the parasitic capacitor Cel of the organic EL element 127 are connected in series, when viewed from the detection transistor 123 or the sampling transistor 125, and the combined capacitance is thus smaller than the capacitance value Cs of the hold capacitor 120. When viewed from the detection transistor 124, on the other hand, the hold capacitor 120 and the parasitic capacitor Cel are connected in parallel, and the combined capacitance is thus larger than the capacitance value Cs of the hold capacitor 120. Therefore, the detection transistor 124 is more robust against the leakage current than the detection transistor 123 or the sampling transistor 125.

In the second embodiment, therefore, as in the first embodiment, the detection transistor 123 and the sampling transistor 125 are formed into an LDD structure, and the LDD length on the side of the drain terminals D of the detection transistor 123 and the sampling transistor 125 (on the side of the hold capacitor 120) is set longer than the LDD length of the drive transistor 121 in order to reduce the leakage current of the detection transistor 123 and the sampling transistor 125.

This configuration is applied to all switching transistors that may affect the voltage held in the hold capacitor 120 (that is, both the detection transistor 123 and the sampling transistor 125) because the effect of the leakage current due to a transistor to which the configuration is not applied would be unacceptable.

With this configuration, the pixel circuit P′ of the second embodiment can also reduce the leakage current of the detection transistor 123 and the sampling transistor 125. This results in a reduction in variations in voltage held in the hold capacitor 120 due to the leakage current of the detection transistor 123 and the sampling transistor 125, and a reduction in variations in image quality due to the leakage current of the detection transistor 123 and the sampling transistor 125. Therefore, uniform image quality can be obtained compared with a case where the second embodiment is not used.

While some embodiments of the present invention have been described, the technical scope of the present invention is not limited to the scope described in the embodiments. Various modifications or improvements may be made to the foregoing embodiments without departing from the scope of the invention, and such modifications or improvements may also fall within the technical scope of the present invention.

The foregoing embodiments are not intended to limit the scope of the appended claims, and all combinations of features disclosed in the foregoing embodiments may not be essential to the present invention. The foregoing embodiments are embodiments of the invention, and various embodiments of the invention can be extracted by combining features disclosed herein. If some of the features disclosed in the embodiments are removed, embodiments that do not include the removed features can be extracted as embodiments of the present invention as long as some of the advantages of the present invention can be achieved.

For example, in the first embodiment, the light-emission control transistor 122 configured to control the light-emission time of the organic EL element 127 within a period of one field is provided in series with the drive transistor 121. As is anticipated from the foregoing description, the pixel circuit P may not necessarily include the light-emission control transistor 122.

In the first embodiment, furthermore, an n-channel transistor to which an active-high drive pulse is supplied is used as the sampling transistor 125. Alternatively, a p-channel transistor to which an active-low drive pulse is supplied may be used. In this case, as described in the foregoing embodiment, the p-channel sampling transistor 125 may be formed into an LDD structure and the LDD length of the sampling transistor 125 may be set longer than the LDD length of the drive transistor 121.

Furthermore, switching transistors connected to the control input terminal of the drive transistor 121 have been described in the context of the sampling transistor 125 configured to selectively feed a signal in accordance with luminance information into the control input terminal (gate terminal G) of the drive transistor 121, and the detection transistor 123 configured to selectively detect the threshold voltage Vth of the drive transistor 121 at the gate terminal G of the drive transistor 121, which is used in a case where the threshold-voltage cancellation circuit 140 configured to correct (cancel) variations in the threshold voltage Vth of the drive transistor 121 is provided. However, any other switching transistor may be used.

A circuit configuration provided on the side of the gate terminal of the drive transistor 121 is not limited to that of the first or second embodiment. A similar configuration may be applied to any switching transistor that is connected to the gate terminal of the drive transistor 121 and whose leakage current may affect the voltage held in the hold capacitor 120.

Such a configuration is applied to all switching transistors whose leakage current may affect the voltage held in the hold capacitor 120, like the detection transistor 123 and the sampling transistor 125 of the second embodiment to which the conditions relating to the LDD length are applied. Otherwise, the effect of the leakage current of the transistor to which the configuration is not applied will not be negligible.

While an organic EL display device including organic EL elements as display elements of pixels has been described by way of example, this is merely an example. Any display device including, as display elements of pixels, electro-optical elements whose luminance varies with a current flowing therethrough may be used.

It should be understood by those skilled in the art that various modifications, combinations, sub-combinations and alterations may occur depending on design requirements and other factors insofar as they are within the scope of the appended claims or the equivalents thereof.

What is claimed is:

1. A pixel circuit comprising:
an electro-optical element configured to emit light in response to a drive signal;
a drive transistor configured to supply the drive signal to the electro-optical element;
a pixel capacitor connected to a control input terminal of the drive transistor;
a switching transistor provided at the control input terminal of the drive transistor; and
a drive-signal stabilizing circuit configured to maintain the drive signal at a constant level,
wherein each of the drive transistor and the switching transistor has a lightly doped drain structure, and
wherein a lightly doped drain region of the switching transistor has a longer length than a lightly doped drain region of the drive transistor.

2. The pixel circuit according to claim 1, wherein the switching transistor includes a sampling transistor configured to selectively feed a signal in accordance with luminance information into the control input terminal of the drive transistor.

3. The pixel circuit according to claim 2, wherein the switching transistor further includes a detection transistor configured to selectively detect a threshold voltage of the drive transistor.

4. A display device comprising:
a pixel array unit including pixel circuits arranged in a matrix, each of the pixel circuits including
an electro-optical element configured to emit light in response to a drive signal,
a drive transistor configured to supply the drive signal to the electro-optical element,
a pixel capacitor connected to a control input terminal of the drive transistor,
a switching transistor provided at the control input terminal of the drive transistor, and
a drive-signal stabilizing circuit configured to maintain the drive signal at a constant level,
wherein each of the drive transistor and the switching transistor has a lightly doped drain structure, and
wherein a lightly doped drain region of the switching transistor has a longer length than a lightly doped drain region of the drive transistor; and
a write scanner configured to selectively supply a signal in accordance with luminance information to each of the control input terminals of the drive transistors of the pixel circuits.
